(19) United States
(12) Patent Application Publication
(10) Pub. No.: US 2005/0283606 A1
(43) Pub. Date: Dec. 22, 2005

(54) Selecting a boot image

(76) Inventor: Mitchell A. Williams, Hillsboro, OR (US)

Correspondence Address: TROP PRUNER & HU, PC, 8554 KATY FREEWAY, SUITE 100, HOUSTON, TX, 77024, US

(21) Appl. No.: 10/873,009

(22) Filed: Jun. 22, 2004

(51) Int. Cl. H04L 9/00

(52) U.S. Cl. 713/166

(57) ABSTRACT

A technique includes selecting a boot image for a remote client from a plurality of boot images based at least in part on an identification of a model of the remote client.

### BACKGROUND

The invention generally relates to selecting a boot image.

A typical network may include various clients that do not have the capability to boot up on their own. For example, these clients may not have mass storage for purposes of storing a boot loader, operating system kernel, operating system files, etc. As another example, the clients may have mass storage but may not be permitted to locally store such data for security reasons; or the clients may be new machines in a manufacturing line that do not yet have the software needed to load up and start up an operating system. For purposes of booting up these clients, the clients may communicate with a boot server over the network.

More specifically, a particular client may include a boot agent that may, for example, support a preboot execution environment on the client to allow simple programs to be run prior to loading the operating system on the client. The pre-execution environment may be used to display a menu through which a user of the client may choose the operating system for purposes of boot up.

A typical network includes clients of many different architectures. For example, some of the clients may be 32 bit architecture machines; and other of the clients may be 64 bit architecture machines. The administrator may define one type of boot image (a boot loader and operating system kernel, for example) to be downloaded to the 32 bit architecture systems and another type of boot image to be downloaded for the 64 bit architecture systems. Such an approach, however, does not permit the system administrator to specify different boot images for different 32 bit systems, for example.

In requesting the boot image, the client typically sends a global unique identifier (called a “GUID”) to the boot server for purposes of uniquely identifying the client relative to the other clients. It is possible for the system administrator to, via a table entry, specify which boot image is to be loaded for a particular specific client based on the client's GUID alone. However, implementation of such a procedure may be too onerous in a large scale network in that the system administrator must, for each GUID, enter the specific boot image to be used for that GUID.

Thus, there is a continuing need for better ways to select a boot image for a client.

### BRIEF DESCRIPTION OF THE DRAWING

FIG. 1 is a schematic diagram of a system according to an embodiment of the invention.

FIG. 2 is a flow diagram depicting a technique to communicate a boot request to a boot server according to an embodiment of the invention.

FIG. 3 is a flow diagram depicting a technique to select a boot image according to an embodiment of the invention.

FIG. 4 is an illustration of a boot request according to an embodiment of the invention.

FIG. 5 is a flow diagram depicting a technique to select a boot image according to another embodiment of the invention.

FIG. 6 is a schematic diagram of a boot server according to an embodiment of the invention.

FIG. 7 is a schematic diagram of a client according to an embodiment of the invention.

### DETAILED DESCRIPTION

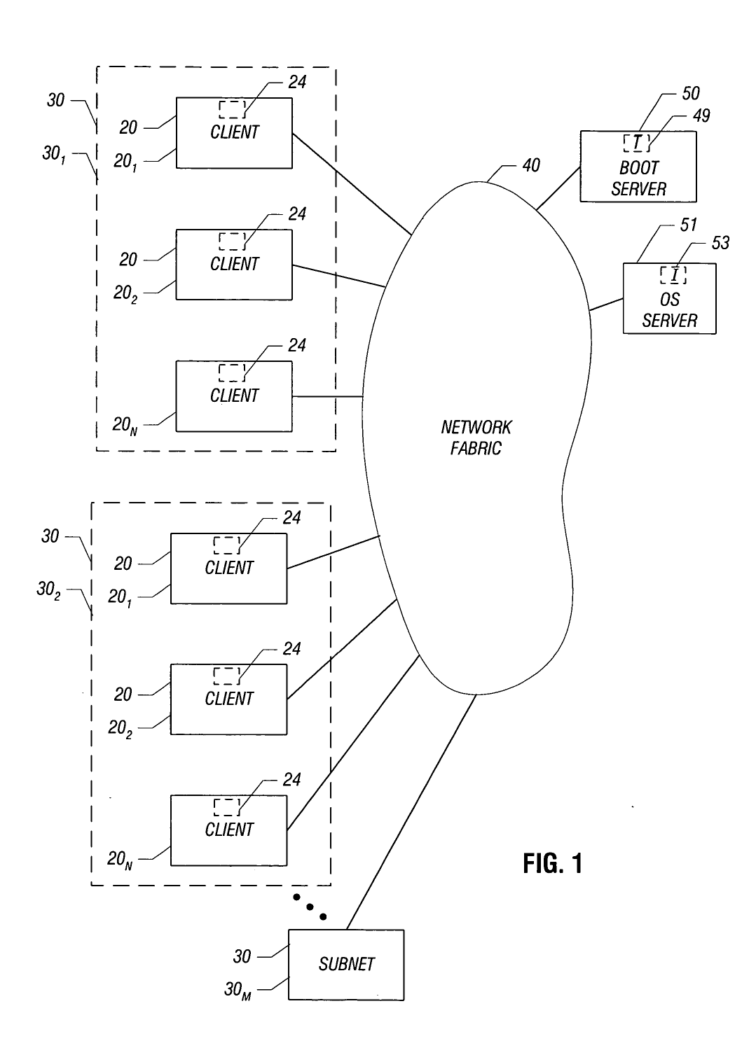

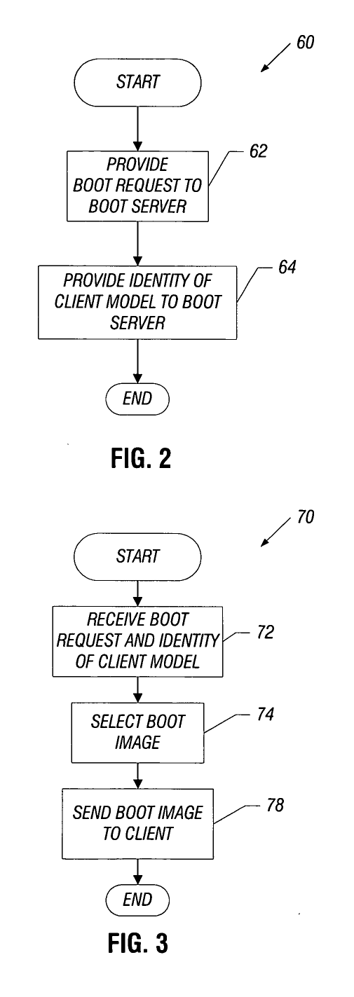

Referring to FIG. 1, an embodiment 10 of a network (a local area network (LAN) or a wide area network (WLAN), as examples) in accordance with the invention includes various clients 20 that are connected through a network fabric 40 to a boot server 50. The clients 20 may be arranged in subnets 30 (subnets 30₁, 30₂ . . . 30ₘ, depicted as examples) that form different segments of the network 40. Furthermore, each subnet 30 may include N clients.

In some embodiments of the invention, each client 20 may rely on the network 10 for purposes of downloading an operating system into the client 20 from an operating system server 51. To accomplish this, each client 20, in some embodiments of the invention, includes a boot agent that resides on the client 20. The boot agent may be established through the execution of instructions 24 that are locally stored on the client 20. On powerup of client 20, the bootup agent establishes a pre-execution environment in which simple programs may be run prior to the operating system boot of the client 20. For example, in some embodiments of the invention, the boot agent may conform to the Preboot Execution Environment (PXE) Specification, Version 2.1, Sep. 20, 1999, available from Intel® Corporation. The boot server 50, in these embodiments of the invention, contains a corresponding agent to interact with the client's boot agent 24; and this agent may also comply with the PXE Specification in some embodiments of the invention.

For purposes of loading the operating system into a particular client 20, the client 20 transmits a boot request to a boot server 50. More specifically, in some embodiments of the invention, a technique 60 may be used by a particular client 20 to request the transfer of a boot image. Pursuant to the technique 60, the client 20 provides (block 62) a boot request to the boot server 50. The client 20 also provides (block 64) an identity of the client model to the boot server 64. In some embodiments of the invention, this indication of the identity of the client model may be included as part of the boot request itself, as further described below.

Due to the indication of the model number in the boot request, the boot server 50 may select a boot image for the client based on its model number. For example, pursuant to a technique 70 that is depicted in FIG. 3, the boot server 50 receives (block 72) the boot request and the identity of the client model and then selects (block 74) the boot image. Based on the selection, the boot server 50 sends (block 78) the boot image to the client 20.

Due to the identification of the model of the client 20, the boot server 50 can assign boot images to a wide class of clients. For example, in some embodiments of the invention, all clients 20 that share the same model type may receive the same boot image. This arrangement allows for easier administration by a system administrator, for example, in that entries of a table that associate boot images to potentially different clients are formed linking specific model types to the boot images. This is less tedious than, for example, linking specific GUIDs to specific boot images.

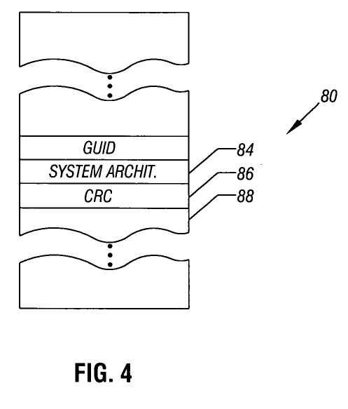

In some embodiments of the invention, not only may the client 20 transmit an indication of the model identification to the boot server 50, the client may also identify the subnet, GUID and architecture of the client 20 so that the boot server 50 may make a determination of the appropriate boot image based on these additional parameters. Referring to FIG. 4, more specifically, in accordance with some embodiments of the invention, a particular boot request 80 that is communicated from the client 20 to the boot server 50 may include a field 82 that indicates the assigned IP (assigned by a DHCP server (not shown)) address of the client. From this IP address, the boot server 50 may determine the subnet that contains the client 20. For example, referring also to FIG. 1, a particular client 20 may be associated with the subnet 30₁, another client 20 may be associated with the subnet 30₂, etc. It is thus possible for the boot server 50, as further described below to select a particular boot image based on at least in part, the subnet of the requesting client 20.

In some embodiments of the invention, the boot request 80 includes a field 84 that contains the GUID for the client 20. As discussed herein, it is possible for the boot server 50 to specifically select a boot image for a particular client 20 based on the identity of that client. Additionally, the boot record 80 includes a field 86, in some embodiments of the invention, that identifies a system architecture of the client 20. This is useful for cases in which the system administrator may decide to install one type of boot image for a 32 bit architecture, for example, and another boot image for a 64 bit architecture, for example.

The boot request 80 also includes a field 88 that identifies the model of the client 20. It is noted that it may be inherent that the identification of the model also identifies the manufacturer of the client 20.

In some embodiments of the invention, for purposes of uniquely identifying the model of the client 20, as compared to other models, the data that is stored in the field 88 is based on some characteristic that is unique to a model. For example, in some embodiments of the invention, the data may be cyclic redundancy check (CRC) code that is formed from particular memory range of the client 20. As a more specific example, in some embodiments of the invention, the field 88 may contain a 32 bit CRC of the user-space-visible basic input output system (BIOS) read only memory (ROM). For example, in a 32 bit PC architecture, this is the 64K segment beginning at “0xF000:0000.”

The CRC value may be used to positively identify the make and model of a particular client 20 but not the specific identity of the client 20. For example, all Brand X model 1 clients 20 may have the same CRC, while all Brand X model 2 clients may have a different CRC. A Brand Y client 20 will have yet another CRC value. Because a 32 bit CRC permits over 4 billion unique values, it is unlikely that any two models will have identical CRC values. An identifier other than a CRC value may be used, in other embodiments of the invention, to uniquely identify a model of the client.

In some embodiments of the invention, after the client has generated the information for the field 88, the client generates the boot request 80 and communicates the boot request to the boot server 50. Between the fields 82, 84, 86 and 88, the boot server 50 has enough information to accurately determine which boot image to send to the client 20.

In some embodiments of the invention, the interaction between the client 20 and the boot server 50 is a two step process that first involves the communication of a boot request to the boot server 50. Next, the boot server 50 selects the boot image and communicates the filename of the selected boot image to the client 20. The client 20 then uses the filename to download the boot image from the appropriate server (such as the boot server 50 (FIG. 1) or an operating system server 51, storing a plurality of boot images 53 (FIG. 1), for example). The selection of the boot image may be aided by entries in a table 49.

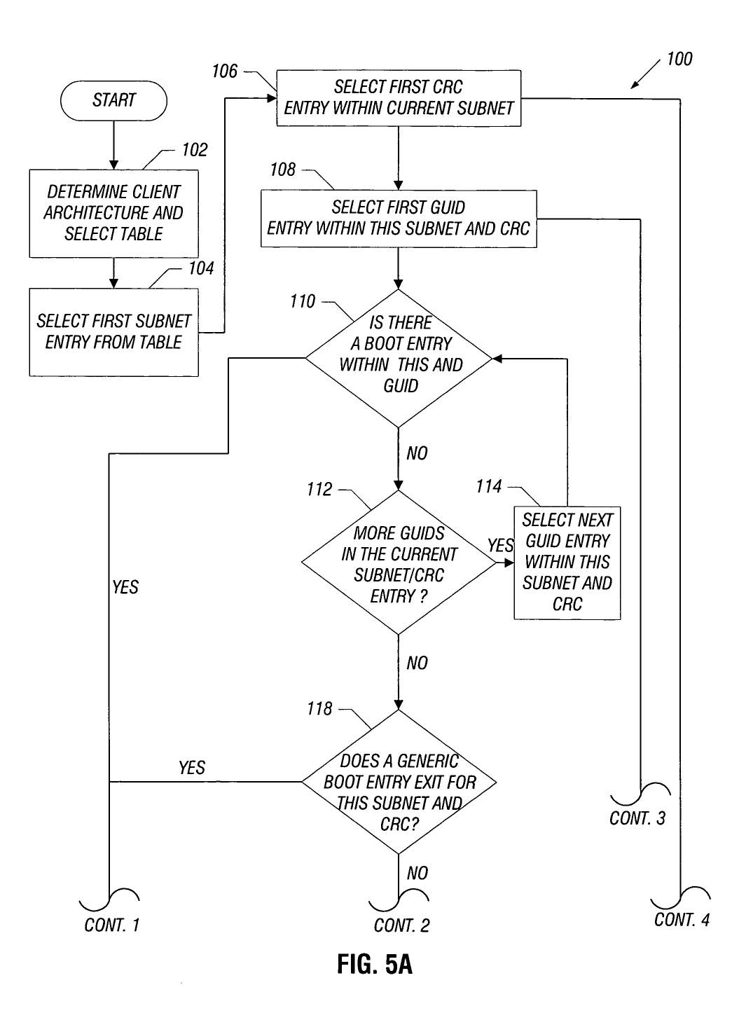

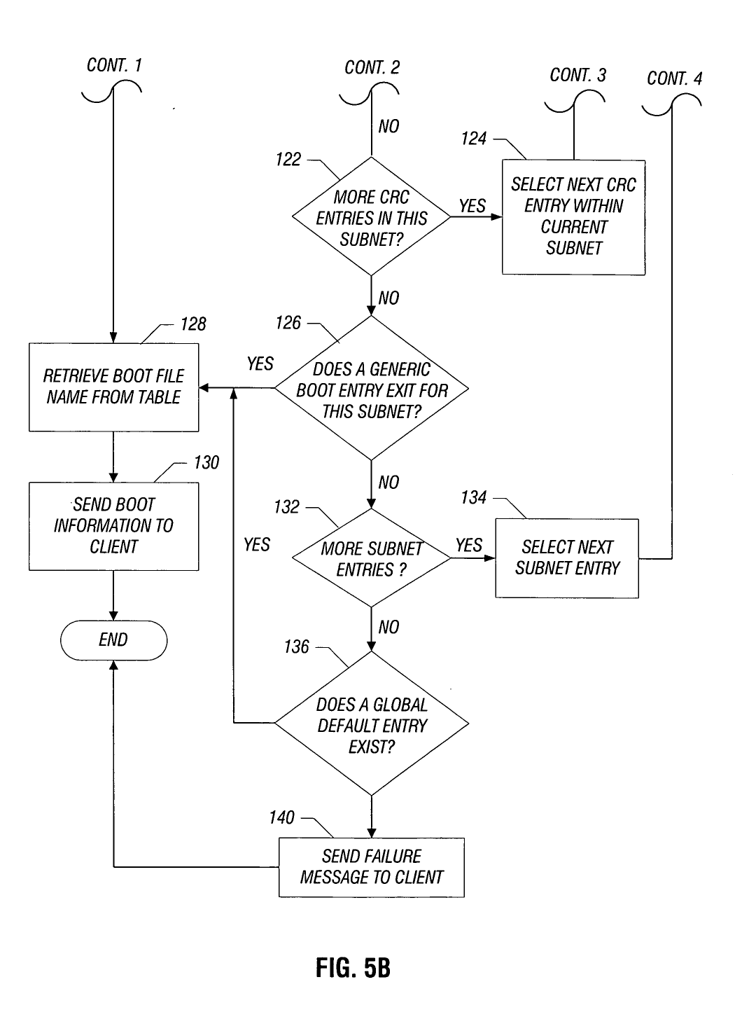

As a more specific example, FIG. 5 depicts a technique 100 for selecting the boot image for a client 20. Pursuant to the technique 100, the boot server 50 determines (block 102) the client architecture (from the field 86) and selects the appropriate table. Thus, in some embodiments of the invention, the boot server 50 may store a set of table entries for each different architecture, such as one set of entries for a 32 bit architecture and another set of entries for a 64 bit architecture.

After determining (block 102) the appropriate client architecture, the boot server 50 selects (block 104) the first subnet entry from the table. In this manner, in some embodiments of the invention, each table may be indexed by subnets, GUID and CRC values. The subnet, being the more general category, identifies a particular subnet of client computers 20, each of which may be identified by a particular GUID and be associated with a particular model.

Next, pursuant to the technique 100, the boot server 50 selects (block 106) the first CRC entry within the current selected subnet and selects (block 108) the first GUID entry within the subnet and CRC entry. If the boot server 50 determines (block 110) that a boot entry exists for the GUID, then the boot server 50 retrieves (block 128) the boot file from a table and sends (block 131) the boot information (a filename of the selected boot image, for example) to the client 20.

If, however, the boot server 50 determines (diamond 110) that a GUID for the boot entry does not exist, then the boot server 50 determines (diamond 112) whether more GUIDs exist in this current subnet/CRC entry. If so, then the boot server 50 selects (block 114) the next GUID entry within the subnet and CRC and returns to diamond 110.

Otherwise, the boot server 50 determines (diamond 118) whether a generic boot entry exists for the subnet and CRC. If so, the boot server 50 retrieves the boot image and sends it to the client, as depicted in blocks 128 and 130. Otherwise, the boot server 50 determines (diamond 122) whether more CRC entries exist in the current subnet. If so, then the boot server 50 selects (block 124) the next CRC entry within the current subnet and returns to block 108. Otherwise, the boot server 50 determines (diamond 126) whether a generic boot entry exists for the subnet. If so, the boot server 50 retrieves the appropriate boot file from the table and sends it to the client, as depicted in blocks 128 and 130. Otherwise, the boot server 50 determines (diamond 132) whether more subnet entries exist. If so, then the boot server 50 selects (block 134) the next subnet entry and returns to block 106.

Otherwise, the boot server 50 determines (diamond 136) whether a global default entry exists. If so, then the server 50 proceeds to block 128 to retrieve and send out the boot image to the client. Otherwise, an error has occurred and the boot server 50 sends (block 140) a failure message to the client 20.

After the receiving the boot image information, the client 20 downloads and installs the boot image. The boot image may, for example, contain an operating system kernel and an operating system boot loader. Upon execution of the boot loader, the client 20 downloads operating system files from the appropriate server, such as the operating system server 51, for example, and then boots up the installed operating system.

Because the above-described hierarchy in selecting the boot image, the network administrator may specify things like the following: all Model X on subnet Y get boot image Z, but all Model X on subnet Q get boot image R; all Model W get boot image S; all systems on subnet L get boot image T; all 64 bit architecture systems on all subnets get boot image U; if GUID A boots from subnet Y, it gets boot image V; and if GUID A boots from subnet L, it gets boot image M.

Thus, the techniques described herein permit a network administrator to control which boot image is sent to a client with exactly the granularity required. Current usage only allows two controls: a system architecture specification and the GUID. The system architecture identification, however, is too broad and in most cases one would not put the same boot image on every 32 bit architecture system on the network, for example. Conversely, the GUID is far too specific for practical use. For example, on a several hundred node network, the administrative burden of correlating each GUID to a specific boot image may be onerous.

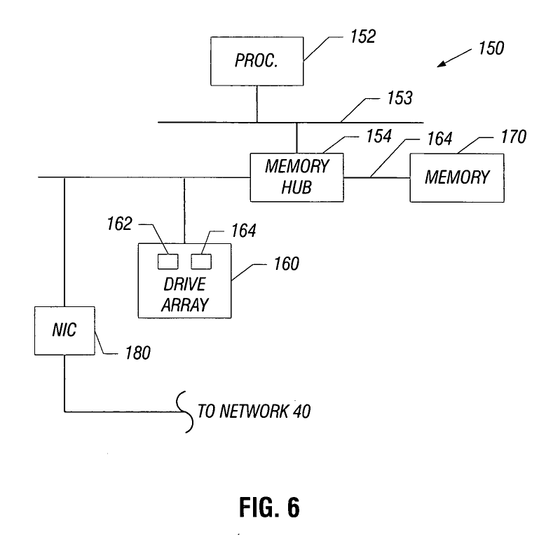

In some embodiments of invention, the boot server 50 may have an architecture 150 that is depicted in FIG. 6. For example, this architecture 150 may include a processor 152 (one or more microprocessors, for example) that is coupled to a system bus 153. The processor 152 may access a memory 170 of the architecture 150 via a memory hub 154 that is also coupled to the system bus 153. The memory hub 154 communicates with the memory 170 via a memory bus 164. Furthermore, the memory hub 154 may be coupled to a drive array 160 that may store, for example, instructions 162 to cause the boot server to perform the technique 100 described above. The drive array 160 may also store various boot image files 164. Additionally, the architecture 150 may include a network interface card (NIC) 180 that couples the boot server to the network fabric 40.

In some embodiments of the invention, the client 20 may have an architecture 200 that is depicted in FIG. 7. In particular, the architecture 200 may be similar to the architecture 150 with the following differences. In some embodiments of the invention, the client 20 may not have a drive array. But rather, the architecture 200 may include a firmware memory 202 that is coupled to the processor 152 for purposes of permitting the processor 152 to access instructions 204 in the firmware memory 202 (a FLASH memory, for example) to cause the processor 152 to generate the boot request and download the boot image. Other embodiments are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. 1. A method comprising:
selecting a boot image for a remote client from a plurality of boot images based at least in part on an identification of a model of the remote client.

2. The method of claim 1, further comprising:
receiving the indication from the client.

3. The method of claim 2, wherein the indication is part of request to boot up client.

4. The method of claim 1, further comprising:
further basing selection of the boot image on existence of an entry linking the model to one of the plurality of boot images.

5. The method of claim 4, further comprising:
in absence of the entry, selecting the boot image for the remote client based on at least in part an identification of a subnet of the remote client.

6. The method of claim 1, further comprising:
determining whether one of the plurality of boot images has been associated with a global identifier uniquely identifying the remote client; and
performing the selection of the boot image based on the determination.

7. The method of claim 1, further comprising:
communicating a filename of the selected boot image to the remote client.

8. The method of claim 1, wherein the identification comprises a status code calculation from a predefined address range of the client.

9. A method comprising:
communicating a boot request to a server to cause the server to identify a boot image to a remote client, the boot request including an indication of an identification of a model of the remote client.

10. The method of claim 9, wherein the request further includes at least one of the following:
an identifier uniquely identifying the remote client, an identification of a subnet of the client, and an identifier identifying an architecture of the client.

11. The method of claim 9, further comprising:
determining a status code to generate the indication.

12. The method of claim 11, further comprising:
forming the status code from a cyclic redundancy code calculated from a predefined address range of the client.

13. An article comprising a computer readable storage medium storing instructions to cause a processor-based system to:
select a boot image for a remote client from a plurality of boot images based on at least in part an identification of a model of the remote client.

14. The article of claim 13, the program storage storing instructions to cause the server to receive the indication from the client.

15. The article of claim 14, wherein the indication is part of a request to boot up the client.

16. The article of claim 14, the storage medium storing instructions to cause the processor to further base selection on existence of an entry linking the model to one of the plurality of boot images.

17. The article of claim 14, the storage medium storing instructions to cause the processor to determine whether one of the plurality of boot images has been associated with a global identifier uniquely identifying the remote client and perform the selection based on the determination.

18. The article of claim 14, wherein the identification comprises a status code calculated from a predefined address range of the client.

19. An article comprising a computer readable storage medium storing instructions to cause a processor-based system to:
communicate a boot request to a server to cause the server to identify a boot image to a remote client, the boot request including an indication of an identification of a model of the remote client.

20. The article of claim 19, wherein the indication comprises a status code.

21. The article of claim 20, wherein the status code comprises a cyclic redundancy check code determined from contents from a predefined address range of the server.

22. An apparatus comprising:
a storage device storing a plurality of boot images; and
a processor to select a boot image for a remote client from the plurality of boot images based at least in part on an identification of a model of the remote client.

23. The apparatus of claim 22, wherein the processor receives the indication from the client.

24. The apparatus of claim 23, wherein the indication is part of a request to boot up the client.

25. The apparatus of claim 22, the processor further basing selection on existence of an entry linking the model to one of the plurality of boot images.

26. The apparatus of claim 25, wherein the processor, in the absence of the entry, selects the boot image for the remote client based on at least in part an identification of subnet of the remote client.

27. A system comprising:
a processor; and
a flash memory to cause the processor to communicate a boot request to a server to cause the server to identify a boot image to a remote client, the boot request including an indication of an identification of a model of the remote client.

28. The system of claim 27, wherein the request further includes at least one of the following:
an identifier uniquely identifying the remote client, an identification of a subnet of the client, and an identifier identifying an architecture of the client.

29. The system of claim 27, wherein the indication comprises a status code.
